(19) United States
(12) Patent Application Publication
(10) Pub. No.: US 2011/0116384 A1
(43) Pub. Date: May 19, 2011

(54) NETWORK CONNECTIVITY MANAGEMENT

(75) Inventors: Scott R. Kotrla, Wylie, TX (US); Matthew W. Turlington, Richardson, TX (US); Michael U. Bencheck, Richardson, TX (US)

(73) Assignee: Verizon Patent and Licensing Inc., Basking Ridge, NJ (US)

(21) Appl. No.: 12/618,259

(22) Filed: Nov. 13, 2009

(51) Int. Cl. H04L 12/26

(52) U.S. Cl. 370/241.1; 370/252; 370/242

(57) ABSTRACT

Network connectivity management includes monitoring a pathway, wherein the pathway is configured to carry a circuit between multiple networks via a provider core network. A determination is made regarding whether the pathway is experiencing a connectivity issue. When it is determined that the pathway is experiencing a connectivity issue, then a message is generated indicating that the circuit is down.

### BACKGROUND

Many telecommunications customers require performance guarantees regarding their network connectivity, particularly for business customers that rely on mission network-based applications. However, troubleshooting network connectivity issues can be challenging, particularly with more complex customer networks. For example, a network service provider may not have access to or control over a customer's networking equipment. Further, the service provider may utilize one networking technology for its high-performance core networks, while providing some other type of networking technology to its customers, thereby increasing the difficulty in troubleshooting network connectivity issues.

### BRIEF DESCRIPTION OF THE DRAWINGS

FIG. 1 illustrates an exemplary system for managing network connectivity between a customer network and a service provider network.

FIG. 2 illustrates another exemplary system illustrating an intermediate access network.

FIG. 3 illustrates an exemplary process for managing network connectivity between a customer network and a service provider core network.

FIG. 4 illustrates an exemplary process for configuring OAM between an access device and a provider edge device.

### DETAILED DESCRIPTION

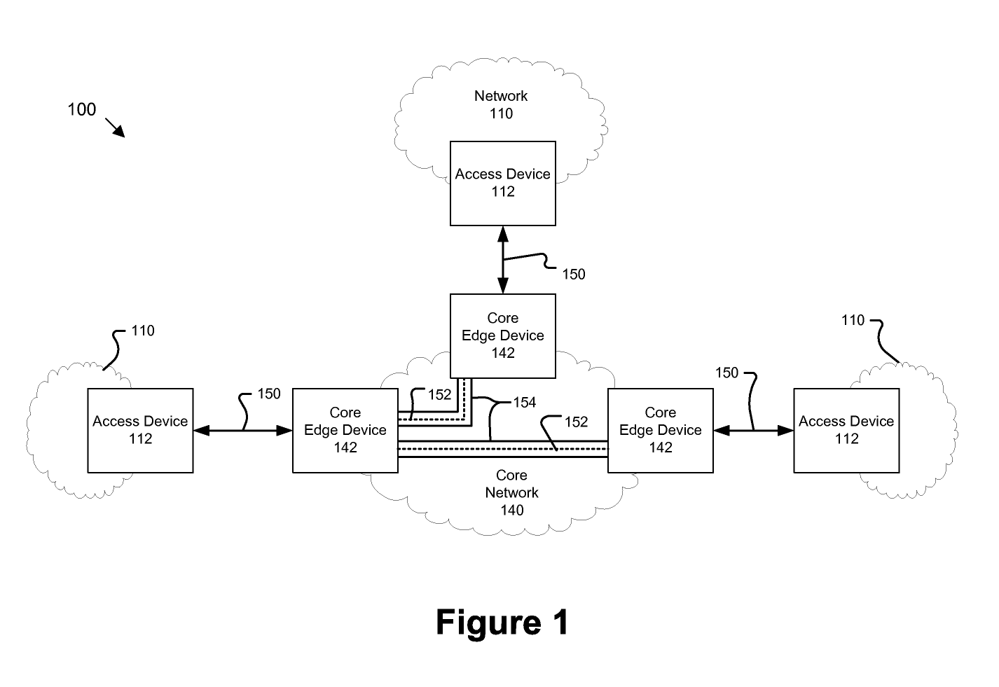

FIG. 1 illustrates an exemplary system 100 for managing network connectivity between at least one network 110 and a service provider core network 140. Core network 140 may utilize one networking technology for its high-performance core network, such as a data link layer networking technology like MultiProtocol Label Switching (MPLS). However, core network 140 may connect to networks 110 via some other type of networking technology, such as Ethernet, for example. Thus, core network 140 and networks 110 may utilize different protocols, and may be utilizing protocols that operate at different layers of the Open System Interconnection Reference Model (OSI Model). Thus, one network may be unable to utilize various Operations, Administration, and Maintenance (OAM) protocols, tools, and services provided by the other network.

For example, a network 110 may be an Ethernet network utilizing certain OAM tools, including IEEE 802.1ag, to monitor the health of a circuit. A circuit may be a logical connection (e.g., a logical communications pathway) over a wide area network between various networks. OAM is a general term that describes the processes, activities, tools, and standards involved with operating, administering, managing, and maintaining any system, including computer networks. 802.1ag is an IEEE standard used in connectivity fault management of an Ethernet network, particularly for paths through 802.1 bridges and local area networks (LANs) to monitor the health of a circuit. An Ethernet network may utilize 802.1ag to monitor an Ethernet Virtual Circuit (EVC), also discussed as a Virtual Local Area Network (VLAN) or Virtual Bridged Local Area Network.

However, because service provider core network 140 may utilize a protocol other than Ethernet, such as MPLS, MPLS OAM functions in the core network are not translated into the Ethernet network. Accordingly, issues affecting core network 140 may not cause alarms, such as 802.1ag messages, to be generated in network 110. Thus, a customer's EVC or VLAN may experience a connectivity issue due to a downed pathway in core network 140, for example, but have difficulty localizing the issue or be forced to wait for a timeout condition to occur before taking corrective actions. System 100 provides mechanisms for troubleshooting a connectivity issue, including translating OAM messages associated with one protocol into an action affecting another network utilizing another protocol. For example, system 100 may be configured to generate Ethernet OAM messages in various networks 110 based on issues affecting core network 140. In one example, system 100 monitors a pathway in core network 140, where the pathway carries a customer's EVC or VLAN. When an issue arises affecting the monitored pathway, system 100 generates an OAM message in network 110 signaling an issue with the customer's EVC or VLAN. Thus, system 100 is able to translate an issue in core network 140 into network 110. In addition, system 100 may be configured to generate messages in multiple networks 110, such as each network 110 that utilizes the monitored pathway.

As illustrated in FIG. 1, exemplary system 100 includes multiple networks 110 that are connected to one another via a service provider core network 140. Network 110 may be an access network associated with a service provider, some portion of a customer network, or some combination thereof. Networks 110 may be geographically separated, but provide access to the same customer (e.g., different customer locations connected by a wide area network provided by core network 140). Generally, each network 110 includes at least one access device 112, which is connected to a provider edge device 142 via one or more physical connection(s) 150. As discussed in detail below, networks 110 may utilize one type of networking technology, such as Ethernet, while core network 140 may utilize another type of networking technology operating at a data link layer, such as MPLS. Certain devices in network 110 may be configured to utilize various OAM messages to monitor connectivity issues associated with a customer's circuit. For example, networks 110 may utilize 802.1ag messages to monitor various virtual connections between access networks 110. System 100 is configured to allow core network 140 to generate OAM messages in network(s) 110 based on issues affecting core network 140, for example, based on connectivity issues affecting a pathway within core network 140.

Networks 110 may be separated geographically and include any number and configuration of wired and/or wireless networks, local area networks, and/or wide area networks. In one example, a business entity includes multiple geographically separated locations represented by networks 110. Such a business entity may desire to connect networks 110 via a wide area network provided at least in part by core network 140. In another example, each network 110 may provide access to a separate business entity, but connect to one another to via core network 140 using one or more circuits 152 to support one or more network-based applications. For example, as discussed above, networks 110 may be Ethernet networks connected to core network 140 via access devices 112 and utilize Ethernet OAM, including 802.1ag. As illustrated in FIG. 1 and discussed in greater detail below, networks 110 may communicate with one another via one or more circuits 152, which are carried by core network 140 via a data link layer pathway 154, such as a pseudowire.

Core network 140 is typically a large-scale, high-performance telecommunications network that directs and carries data from one network node to the next. In one example, core network 140 is a collection of networks utilizing a data link layer core network, such as MPLS. Of course, core network 140 may additionally or alternatively utilize other protocols as well, such as Asynchronous Transfer Mode (ATM), Frame Relay, or some other data link layer protocol. In addition, core network 140 may provide network communication services to networks 110 via provider edge devices 142, including supporting circuits 152, such as VLAN tunneling and/or Ethernet Virtual Circuits (EVCs). In addition, core network 140 may utilize one or more pathways 154, such as pseudowires, to facilitate communications between various provider edge devices 142. Pathway 154 may be an emulated or virtual wire, such as a data link layer pathway or pseudowire, which emulates the operation of a wire carrying circuit 152, for example. Generally, there is a one-to-one relationship between a circuit 152 and a pathway 154, as illustrated in FIG. 1. Further, core network 140 typically utilizes OAM messages that correspond to the communications protocol being utilized, for example, core network 140 may utilize data link layer OAM messages, such as MPLS OAM messages, to identify and respond to certain connectivity issues.

Access devices 112 and provider edge devices 142 are networking devices that facilitate telecommunications services between a network 110 and core network 140. Generally, devices 112, 142 provide entry points into enterprise or service provider core networks, such as core network 140. For example, devices 112, 142 may be a router, a routing switch, an integrated access device, a multiplexer, or any of a variety of metropolitan area network (MAN) and wide area network (WAN) access devices.

In one example, provider edge device 142 is an MPLS Label Edge Router (LER) that terminates an Ethernet Access Network and hands off network traffic from network 110 to an MPLS core network within core network 140. Provider edge device 142 may be configured to receive IP datagrams from network 110, determine appropriate labels to affix to the IP datagrams using routing information, and then forward the labeled packets to the core network 140. Provider edge device 142 may also be configured to receive labeled packets from core network 140, and strip-off the label and forward the resulting IP packet to network 110. In addition, provider edge device 142 may support data link layer pathways 154, such as pseudowires, between provider edge devices 142 to carry network traffic.

Further, provider edge device 142 may support circuits 152, such as EVCs and/or VLAN tunnels, to create virtual connections between networks 110 via core network 140. In one example, provider edge device 142 is configured to generate 802.1ag OAM messages in response to various connectivity issues involving pathway 154. For example, provider edge device 142 may be configured to identify a pathway 154 to monitor, and receive an indication of a connectivity issue with the monitored pathway 154, such as a physical failure, e.g., a port down message, a label withdrawn message, or some other indication. Provider edge device 142 may be further configured to generate 802.1ag messages in response to inform access devices 112 in access networks 110 that the associated circuit 152 is having a connectivity issue.

Generally, OAM messages, including 802.1ag messages, may contain an address, a time stamp, a sequence number, and some identifying information regarding a circuit. The time interval between various OAM messages, such as 802.1ag messages, is configurable. For example, the time interval between messages may be as low as 3.3 ms and as high as 1 minute. In one example, system 100 would be configured to use a time interval of approximately between 10 ms to 1 second. The time interval may be dependent on the type of service being monitored, or based on a service level agreement (SLA). In one example, system 100 utilizes 802.1ag Continuity Check Messages (CCMs) to monitor a circuit.

802.1ag OAM messages may include Continuity Check Messages (CCMs), which are generally based on a time interval. Typically, a CCM messages is a multicast message that may include a time stamp, a sequence number, address information regarding the sending device, or some other information. A CCM may be used to monitor the health of a circuit, such as a VLAN tunnel or Ethernet Virtual Circuit (EVC). 802.1ag OAM messages may also include Traceroute Message and Reply (TRM, TRR) and Loopback Message and Reply (LBM, LBR), which may be multicast from one hop along a network to the next hop to help isolate a particular continuity issue. System 100 may also be configured to generate a Remote Defect Indicator (RDI) message, an Alarm Indication Signal (AIS), and/or an interface status type link value (TLV) message in response to connectivity issue affecting a pathway 154.

In one example, access devices 112 are configured to send and receive Ethernet OAM messages, including 802.1ag messages via core network 140, to monitor the health of a circuit 152. Provider edge device 142 may be configured to detect an issue affecting a pathway 154 carrying a particular circuit 152, and generate an Ethernet OAM message in response, for example, by sending an interface status TLV message from provider edge device 142 to access device 112, thus translating a core network 140 issue into access networks 110 affected by the connectivity issue.

As illustrated in FIG. 1, networks 110 are connected to one another via circuits 152, which are carried via pathways 154 in core network 140. For example, Ethernet circuits may be carried across an MPLS core network using pseudowires. Of course, networks 110 may have many circuits 152 to many different networks, including multiple circuits 152 between any two networks 110. Further, core network 140 may utilize multiple pathways 154 between two networks 110. For example, core network 140 may define multiple failover pseudowires between networks 110.

In general, computing systems and/or devices, such as devices 112, 142, and the various network/communications devices used in networks 110, 140 may employ any of a number of well known operating systems, including, but by no means limited to, various versions and/or varieties of the Cisco IOS® (originally Internetwork Operating System), Juniper Networks JUNOS®, Alcatel-Lucent Service Router Operating System (SR OS), or any of a number of other such operating systems. Further, such systems and/or devices may employ utilize one or more of the following: Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system.

Computing devices generally include computer-executable instructions, where the instructions may be executable by one or more computing devices such as those listed above. Computer-executable instructions may be compiled or interpreted from computer programs created using a variety of well known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any tangible medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

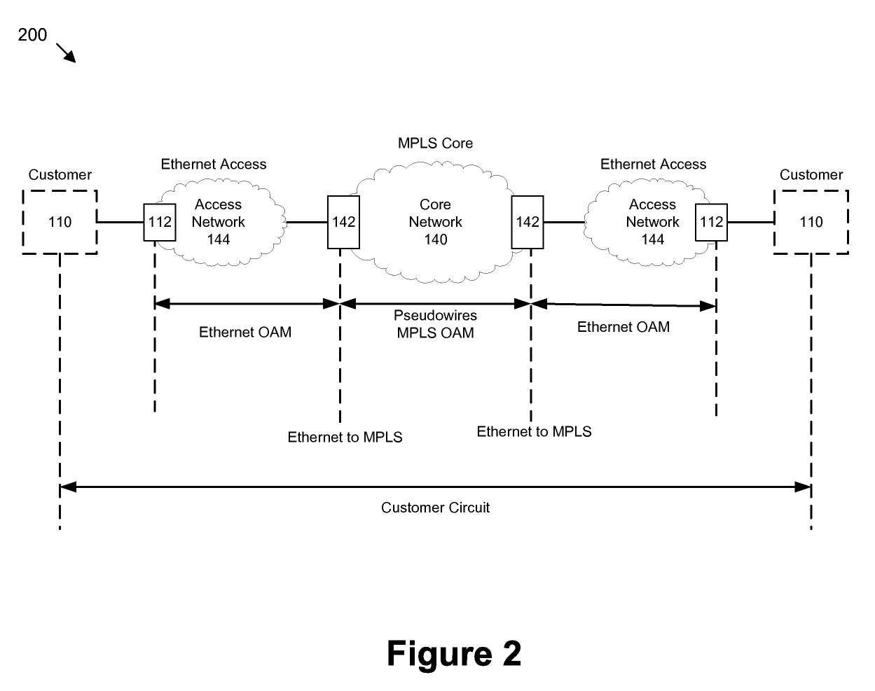

FIG. 2 illustrates another exemplary system 200 where at least one network 110 is connected to core network 140 via an access network 144. Access networks 144 may be part of a larger communications network used to connect networks 110 to core network 140. For example, core network 140 may be a core network utilizing MPLS for network communications, and access networks 144 may be used to interconnect a customer's Ethernet network to the MPLS core network 140. As illustrated in FIG. 2, networks 110 may be interconnected to one another via established circuits 152. Further, access networks 144 may utilize access devices 112 to communicate with core network 140 via provider edge devices 142, as illustrated in FIG. 2.

A circuit 152 may be an Ethernet Virtual Connection (EVC), an Ethernet Virtual Private Line (EVPL), a VLAN, a Virtual Private Network (VPN) tunnel, or some other mechanism to define a point-to-point Ethernet connection between networks 110 via core network 140. In an Ethernet access network 144, circuits 152 (e.g., EVCs and/or customer VLAN tunnels) interconnect networks 110 and are generally delineated and identified by VLAN tags. To monitor the health of a circuit 152, access devices 112 may be configured to communicate 802.1ag OAM messages over the circuit 152. Such Ethernet OAM messages are bi-directional, and thus the access device 112 at each end of the circuit 152 could be configured to send and receive such OAM messages.

As previously discussed, because networks 110 and core network 140 may utilize different networking technologies, certain OAM functionalities may be inaccessible to one of the networks. Thus, if a pathway 154 is having a connectivity issue, customer networks 110 may be aware of the issue, but unable to localize the issue or be forced to wait for a timeout to occur before taking corrective actions. As illustrated in FIG. 2, Ethernet OAM messages may be communicated between networks 110 (provided the appropriate communications links are functioning), as well as between a network 110 and an access network 144. As discussed in greater detail below, system 100 translates core network 140 connectivity issues into access networks 144. For example, in response to a downed pseudowire, provider edge devices 142 may send various messages, such as interface status TLV messages, to access devices 112 to inform customer networks 110 and access networks 144 of an issue affecting a customer's circuit.

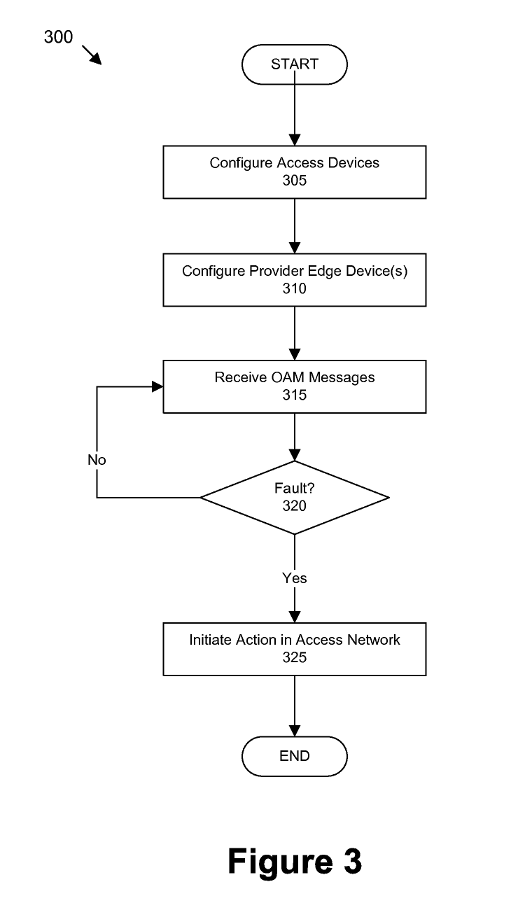

FIG. 3 illustrates an exemplary process 300 for managing network connectivity between a network 110 and a service core network 140. Process 300 begins in block 305 by configuring access devices 112. Generally, access devices 112 are configured to connect to a provider edge device 142 and establishing a circuit 152 between networks 110. Further, access devices 112 are configured to utilize OAM messages, such as 802.1ag messages, to monitor the health and status of circuit 152. For example, access devices 112 may be configured to send, receive, and respond to various messages, including various Continuity Check Message (CCM). For example, access devices 112 may be configured to receive and respond to a Remote Defect Indicator (RDI), an Alarm Indication Signals (AIS), and/or an interface status type link value (TLV) message.

Next, in block 310, a provider edge device 142 is configured. For example, provider edge devices 142 may be configured to encapsulate network traffic received from one network 110 and route that traffic via a pathway 154 to another network 110. Generally, provider edge devices 142 may be configured to carry a circuit 152 between networks 110 via a pathway 154. Further, provider edge device 142 may be configured to respond to certain pre-determined OAM messages, such as those indicative of a connectivity issue with a pathway 154. In one example, provider edge devices 142 may be configured to utilize CCM, AIS, RDI, and/or interface status TLV messages to inform an access device 112 that a pathway 154, such as a pseudowire, is experiencing a connectivity issue. Provider edge devices 142 may maintain a table and/or database of circuits 152 and their associated pathway 154. Thus, if a pathway 154 experiences a connectivity issue, provider edge device 142 can identify the associated circuit 152 and inform an access device 112 associated with the circuit 152 carried by pathway 154 that a connectivity issue has occurred. As discussed in greater detail below with respect to process 400, provider edge device 142 and access device 112 may also be configured to utilize OAM messages, such as 802.1ag.

Next, in block 315, OAM messages are generated and received by a provider edge device 142. For example, provider edge device 142 may be configured to receive OAM messages regarding the status of one or more pathways 154. In one example, provider edge devices are configured to monitor for a label withdrawn indicator, a port down indicator, and/or a link fault message associated with a pathway 154.

Next, in decision diamond 320, a fault determination is made regarding a pathway 154 in core network 140. In one example, provider edge device 142 monitors for any message indicating a connectivity issue associated with one or more pathways 154, such as a pseudowire. Based on such messages, provider edge device 142 determines whether a fault has occurred. For example, provider edge device 142 may be configured to receive a port down, a label withdrawn, or some other message indicative of an issue with a pseudowire. If there is no fault, then process 300 returns to block 315 and continues to receive and monitor OAM messages. If a fault is determined, then process 300 continues to block 325.

In block 325, corrective actions are initiated in response to the fault determination. For example, provider edge device 142 may be configured to send an interface status TLV message to an access device 112 indicating that circuit 152 is down, thus translating a core network 140 connectivity issue into access network 144 and/or customer network 110. In another example, provider edge device 142 may instruct an access device 112 to stop sending CCM messages to other devices in access network 144 and/or customer network 110. Further, provider edge devices 142 may be configured to send an AIS message when a problem is detected in core network 140 with respect to a pathway 154. Generally, provider edge device 142 will determine which pathway 154 experienced a fault, identify the associated circuit 152, and generate a message indicating that circuit 152 is down, such as by generating and sending an 802.1ag message to an access device 112. In another example, provider edge devices 142 on either side of pathway 154 generate Ethernet OAM messages to an access device 112 to inform the access devices 112 that a customer's EVC and/or VLAN is down. Thus, an indication of a failure of a pathway 154 in core network 140 may be translated into networks 144 and/or 110, which may utilize a different protocol. Following block 325, process 300 ends.

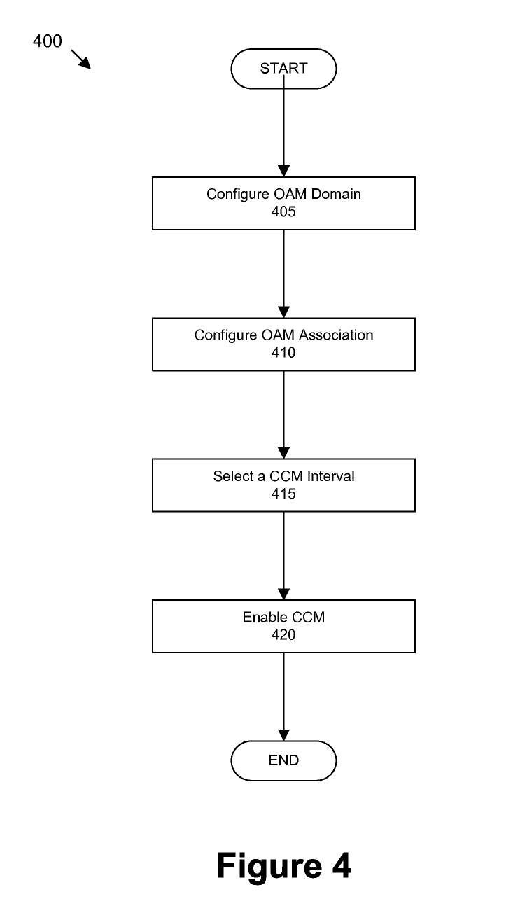

FIG. 4 illustrates an exemplary process 400 for configuring OAM between an access device 112 and a provider edge device 142. As previously discussed, an access device 112 and a provider edge device 142 may be configured to utilize Ethernet OAM, such as 802.1ag to monitor the health of a circuit. Process 400 begins in block 405 by configuring an OAM domain. For example, in order for access device 112 and provider edge device 142 to start exchanging Ethernet OAM, each device must be configured to be part of the same OAM domain. Thus, in block 405, access device 112 in access network 144 and a provider edge device 142 that faces the particular access network 144 are both configured to be part of the same OAM domain.

Next, in block 410, an OAM association is configured. Generally, access device 112 and provider edge device 142 are each configured to be maintenance entity points (MEPs) with appropriate MEP identification such that each will process OAM messages with from the other. For example, once configured with the appropriate association, access device 112 and provider edge device 142 will process each other's CCMs, as opposed to merely passing the CCM along to another entity. Further, each can then respond to various messages that indicate a problem has occurred with respect to a circuit.

Next, in block 415, a continuity check interval is selected. The continuity check interval determines how much time must pass without receiving a CCM before determining that a fault has occurred. The interval may be as short as 3.3 milliseconds, and may be as long as 10 minutes. The selection of the CCM interval may depend on any number of factors. The longer the CCM interval, the longer the process takes to detect a fault. However, should an interval be too short, the system may trigger false alarms. Generally, access device 112 and provider edge device 142 are each configured with a similar CCM interval. However, each may be configured with a different CCM interval. In addition to the continuity check interval, other criteria relating to CCMs may be configured. For example, a continuity check loss threshold may also be configured on each device. The continuity check loss threshold determines the number of continuity check messages that can be lost before marking the MEP as down. The default value is 3 protocol data units (PDUs).

Next, in block 420, each device is configured to enable CCMs. For example, CCMs are enabled on access device 112 and provider edge device 142 such that each will send CCMs to one another. Following block 420, process 400 ends.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A method, comprising:
identifying a pathway to monitor, wherein the pathway is configured to carry a circuit between multiple networks via a provider core network;
determining, in a computing device, if the pathway is experiencing a connectivity issue;
identifying a circuit associated with the pathway; and
when it is determined that the pathway is experiencing a connectivity issue, then generating a message indicating that the circuit is down.

2. The method of claim 1, wherein the pathway is a data link layer pathway.

3. The method of claim 1, wherein the circuit is at least one of an Ethernet Virtual Connection (EVC), an Ethernet Virtual Private Line (EVPL), a Virtual Local Area Network (VLAN), and a Virtual Private Network (VPN) Tunnel.

4. The method of claim 1, wherein the circuit is a Virtual Local Area Network (VLAN) tunnel and identified by a Virtual Local Area Network (VLAN) tag.

5. The method of claim 1, wherein the message indicating that the circuit is down is an Ethernet OAM message in accordance with IEEE 802.1ag.

6. The method of claim 1, further comprising determining if the pathway is experiencing a connectivity issue in a provider edge device.

7. The method of claim 6, wherein the provider edge device is a MultiProtocol Label Switching (MPLS) label edge router.

8. The method of claim 1, further comprising sending at least one of a Remote Defect Indicator (RDI), an Alarm Indication Signal (AIS), and an interface status type link value (TLV) message to an access device when it is determined that the pathway is experiencing a connectivity issue.

9. A system, comprising:
a provider network configured to facilitate data communications between a plurality of networks using a data link layer communications protocol;
a circuit configured to create a logical communications pathway between at least two of the plurality of networks via the provider network;
a pseudowire configured to support the circuit, wherein the pseudowire is associated with a data link layer communications protocol;
an access device communicatively coupled to at least one of the plurality of networks; and
a provider edge device communicatively coupled to the access device, the provider edge device being configured to hand off network traffic from at least one network to the provider network, wherein the provider edge device is configured to:
determine if a pathway is experiencing a connectivity issue;
identify a circuit associated with the pathway; and
when it is determined that the pathway is experiencing a connectivity issue, then send a message to an access device associated with the circuit indicating that the circuit is experiencing a connectivity issue.

10. The system of claim 9, wherein the data link layer communications protocol is at least one of MultiProtocol Label Switching (MPLS), Frame Relay, and Asynchronous Transfer Mode (ATM).

11. The system of claim 9, wherein the network communicatively coupled to the access device utilizes Ethernet, and the access device is configured to facilitate communication between the Ethernet network and the provider network.

12. The system of claim 9, wherein the circuit is at least one of an Ethernet Virtual Connection (EVC), an Ethernet Virtual Private Line (EVPL), a Virtual Local Area Network (VLAN), and a Virtual Private Network (VPN) Tunnel.

13. The system of claim 9, wherein the circuit is a Virtual Local Area Network (VLAN) tunnel and identified by a Virtual Local Area Network (VLAN) tag.

14. The system of claim 9, wherein the message sent by the provider edge device is an Ethernet OAM message in accordance with IEEE 802.1ag.

15. The system of claim 9, wherein the provider edge device is a MultiProtocol Label Switching (MPLS) label edge router.

16. The system of claim 9, wherein the provider edge device is further configured send at least one of a Remote Defect Indicator (RDI),an Alarm Indication Signal (AIS), and an interface status type link value (TLV) message to an access device when it is determined that the pathway is experiencing a connectivity issue.

17. A computer-readable medium tangibly embodying computer-executable instructions configured to:
facilitate data communication between a network and a provider network, wherein the provider network is configured to utilize a first protocol and the network is configured to utilize a second protocol;
identify a pseudowire to monitor, wherein the pseudowire is configured to carry a circuit between multiple networks via the provider network;
determine if the pseudowire is experiencing a connectivity;
identify a circuit associated with the pseudowire; and
send a message indicating that the circuit is experiencing a connectivity issue when it is determined that the pseudowire is experiencing a connectivity issue.

18. The computer-readable medium of claim 17, wherein the first protocol is at least one of MultiProtocol Label Switching (MPLS), Frame Relay, and Asynchronous Transfer Mode (ATM), and wherein the second protocol is Ethernet.

19. The computer-readable medium of claim 17, further comprising computer-executable instructions configured to send an alert to a customer associated with the circuit when it is determined that the pseudowire is experiencing a connectivity issue.

20. The computer-readable medium of claim 17, further comprising computer-executable instructions configured to send at least one of a Remote Defect Indicator (RDI),an Alarm Indication Signal (AIS), and an interface status type link value (TLV) message to an access device associated with the circuit indicating that the circuit is experiencing a connectivity issue when it is determined that the pseudowire is experiencing a connectivity issue.
